(19) United States
(12) Patent Application Publication
(10) Pub. No.: US 2026/0187870 A1
(43) Pub. Date: Jul. 2, 2026

(54) GEOMETRIC SEGMENT FITTING FOR PARALLEL PROCESSING SYSTEMS AND APPLICATIONS

(71) Applicant: NVIDIA Corporation, Santa Clara, CA (US)

(72) Inventor: David Zhao Akeley, Sunnyvale, CA (US)

(21) Appl. No.: 19/001,896

(22) Filed: Dec. 26, 2024

(51) Int. Cl. G06T 11/20; G06T 1/20; G06T 7/00; G06T 7/543; G06T 7/60

(52) U.S. Cl. CPC G06T 11/23; G06T 1/20; G06T 7/0006; G06T 7/543; G06T 7/60; G06T 2207/30141

(57) ABSTRACT

In various examples, one or more iterations may be performed in which merge candidate candidates for a sequence of geometric segments (e.g., cubic Bézier curves) are evaluated, and potentially used to update the sequence. A result of an evaluation may be based on one or more proximities between a merge candidate and a point(s) to which the merge candidate is being fit. Evaluations me be performed for a merge candidate(s) with respect to different geometric segments in the sequence. Where results of the evaluations are compatible for the merge candidate(s) (e.g., both results select and/or agree with the merge) the merge candidate may be accepted. Where the results are incompatible for the merge candidate(s) (e.g., at least one result does not select and/or agree with the merge) the merge candidate may be rejected. The sequence may be tracked and updated using a mapping between segments and corresponding base points.

### BACKGROUND

Cubic Bézier curves are widely used in computer graphics, animation, and design software due to their ability to represent smooth, scalable curves with a high degree of precision and control. For example, cubic Bézier curves may be used to create smooth paths for motion animation of graphics, vector graphics, fonts, and modeled surfaces in computer-aided design (CAD) software. Bézier curve fitting may be used to approximate a shape or set of data points using Bézier curves, such as to simplify complex shapes, reduce data storage requirements, or create editable versions of raster images.

Conventional approaches to Bézier curve fitting use recursive subdivision, where a sequence of points is fit to a single cubic Bézier curve, the sequence of points is subdivided into two smaller sequences if the error between the curve and the points exceeds a predefined threshold, and the fitting process is recursively applied to each sub-sequence. However, suboptimal curve fitting may arise from using heuristics to choose the locations to subdivide the sequence. Additionally, the recursive nature of the algorithm may be unsuitable for parallel processing circuitry due to, for example, branching caused by recursion—resulting in control flow divergence between threads, dynamic memory requirements for tracking the branches, and inefficiencies in reduction operations used to synchronize the threads.

### SUMMARY

Embodiments of the present disclosure relate to geometric segment fitting for parallel processing systems and applications. Systems and methods are disclosed that may be used to efficiently fit geometric segments, such as Bézier curves, to geometry using parallel processing circuitry.

In contrast to conventional approaches, such as those described above, disclosed approaches may perform one or more iterations of evaluating candidate segments (merge candidates) that merge or combine respective sets of points corresponding to segments from a sequence of geometric segments (e.g., cubic Bézier curves), and updating the sequence based on the evaluation of the merge candidates. In at least one embodiment, threads may respectively be assigned segments and/or points to parallelize the evaluation and merging of one or more corresponding merge candidates. A result of an evaluation may be based on one or more proximities between a merge candidate and a point(s) to which the merge candidate is being fit. A merge candidate(s) that is evaluated by multiple threads may be rejected or accepted based on the results of the evaluations. Where the results are compatible for the merge candidate(s) (e.g., both results select and/or agree with the merge) the merge candidate may be included in the update. Where the results are incompatible for the merge candidate(s) (e.g., at least one result does not select and/or agree with the merge) the merge candidate may be rejected from the update. The sequence of geometric segments may be tracked and updated using a mapping between segments and corresponding base points.

### BRIEF DESCRIPTION OF THE DRAWINGS

The present systems and methods for geometric segment fitting for parallel processing systems and applications are described in detail below with reference to the attached drawing figures, wherein:

FIG. 1 includes a data flow diagram for an example of a process for geometric segment fitting, in accordance with some embodiments of the present disclosure;

FIG. 2 includes example illustrations of sequences of geometric segments fit with respect to a printed circuit board design, in accordance with some embodiments of the present disclosure;

FIG. 3A includes a data flow diagram of a sequence of geometric segments being fit to a sequence of points, in accordance with some embodiments of the present disclosure;

FIG. 3B continues the data flow diagram of FIG. 3A, in accordance with some embodiments of the present disclosure;

FIG. 4 is a flow diagram showing a method for replacing geometric segments in a sequence of geometric segments based on an evaluation of one or more merge candidates, in accordance with some embodiments of the present disclosure;

FIG. 5 is a flow diagram showing a method for updating a sequence of geometric segments based on evaluations of sets of merge candidates for geometric segments, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to geometric segment fitting for parallel processing systems and applications. Disclosed approaches may perform one or more iterations of one or more independent evaluations (e.g., in parallel) of candidate segments (e.g., merge candidates) to merge or combine respective sets of points corresponding to segments from a sequence of geometric segments (e.g., cubic Bézier curves), and an update to the sequence (e.g., in parallel using a prefix scan) based on the evaluation of the merge candidates. Any number of subsequent iterations may use an updated sequence to further refine the sequence of geometric segments. By evaluating merge candidates to merge geometric segments from the sequence, geometric segments can be fit to the points without requiring recursive branching—allowing for control flow alignment between threads, predictable memory requirements, and efficient reduction operations suitable for parallel processing implementations.

In at least one embodiment, threads may respectively be assigned segments and/or base points in the sequence of geometric segments for evaluation of one or more corresponding ones of the merge candidates in parallel. For example, each thread may evaluate, for a segment(s), a merge candidate(s) that corresponds to the segment and at least one segment (that is assigned to a different thread) to the left of the segment (a left merge candidate). Similarly, each thread may evaluate, for the segment(s), another merge candidate(s) that corresponds to the segment and at least one segment (that is assigned to a different thread) to the right of the segment (a right merge candidate).

A result of an evaluation by a thread may include, by way of example, any combination of a selection(s) of a preferred or required merge candidate(s) for a merge, a ranking or scoring of an evaluated merge candidate(s) for the merge, and/or a selection(s) of an unpreferred, disfavored, or prohibited merge candidate(s) for the merge. In at least one embodiment, a thread selects between a left merge candidate, a right merge candidate, or a no merge option. The evaluation for a merge candidate may be based on various potential criteria, such as one or more proximities between the merge candidate and the points to which the merge candidate is being fit. In at least one embodiment, a merge candidate may be selected or rejected for a merge based at least on the evaluation comparing the one or more proximities to one or more threshold values and/or computing a score or ranking based on a magnitude(s) of the one or more proximities (e.g., to favor closer fits to the points).

In at least one embodiment, the sequence of geometric segments may be updated based on the results of the evaluations of the merge candidates. For example, a merge candidate(s) that is evaluated by multiple threads may be rejected or accepted for the update based on the results of the evaluations. In at least one embodiment, where the results are compatible for the merge candidate(s) (e.g., both results select and/or agree with the merge) the merge candidate may be included in the update. Where the results are incompatible for the merge candidate(s) (e.g., at least one result does not select and/or agree with the merge) the merge candidate may be rejected from the update. In at least one embodiment, the results corresponding to each adjacent segment (e.g., a left merge candidate for one segment that is a right merge for another segment) may be evaluated (e.g., compared) to determine whether to include the merge candidate in an update.

In at least one embodiment, the sequence of geometric segments may be tracked using a mapping between segments and corresponding base points. An update to the sequence may include, for each selected merge candidate, remapping the points that correspond to merged segments to the merge candidate. In at least one embodiment, multiple threads may evaluate one or more of the results to determine whether to accept or reject a same merge candidate(s) in parallel (e.g., using a parallel reduction) and may implement the update (e.g., remapping).

While the disclosure primarily describes examples where the geometric segments include curves, the geometric segments may include any combination of one or more of cubic Bézier curves, Bézier curves, curves, two-dimensional shapes, geometric primitives, circles, ellipses, rectangles, triangles, polygons, parabolas, hyperbolas, superellipses, lines, convex hulls, triangulations, partitions, splines, Non-Uniform Rational B-Splines (NURBS), level sets, affine transformations, or projective transformations.

Additionally, while the disclosure primarily describes examples where the geometric segments are fit to a sequence of points, the geometric segments may fit various types of reference geometry, examples of which may include any combination of pixels, base points, image or object features, gradient fields, surfaces, curves, edges, vertices, parametric surfaces, contours, splines, boundary representations, implicit functions, control points, axis-aligned bounding boxes, or models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

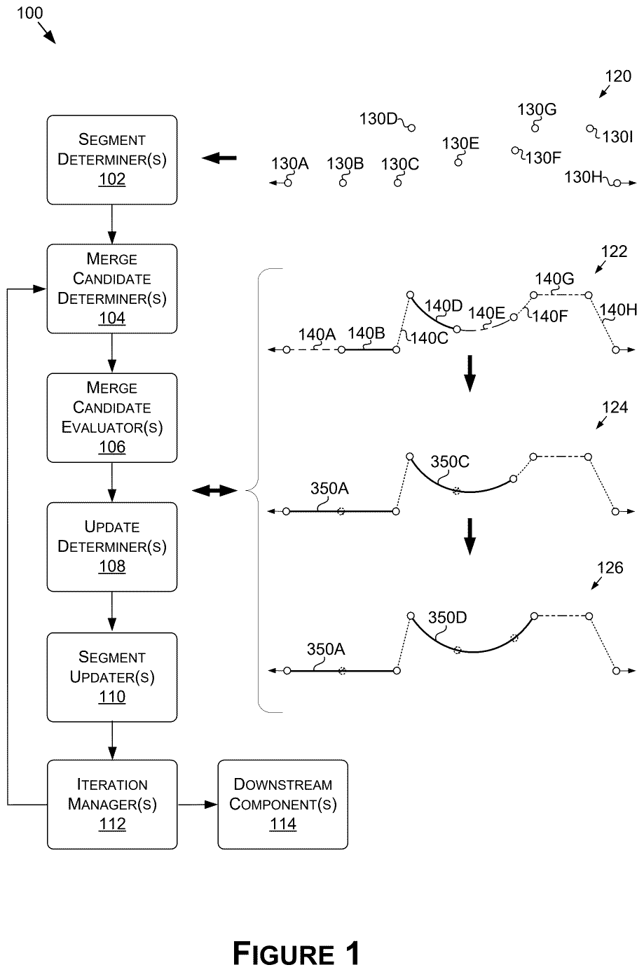

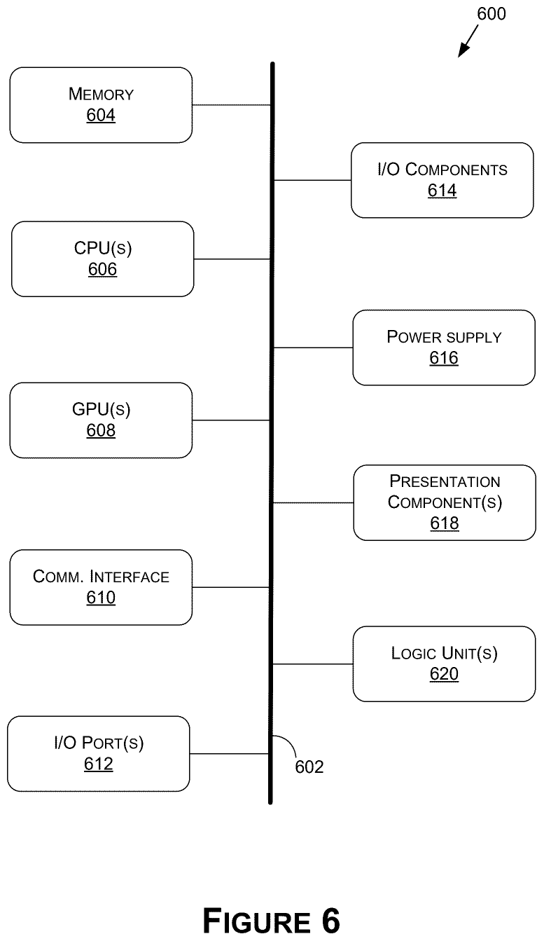

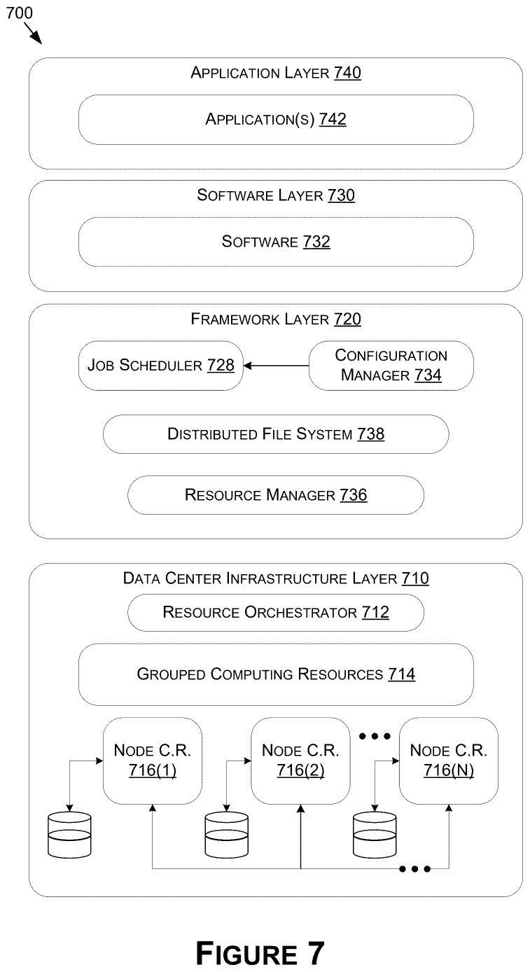

With reference to FIG. 1, FIG. 1 includes a data flow diagram for an example of a process 100 for geometric segment fitting, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 600 of FIG. 6, and/or example data center 700 of FIG. 7.

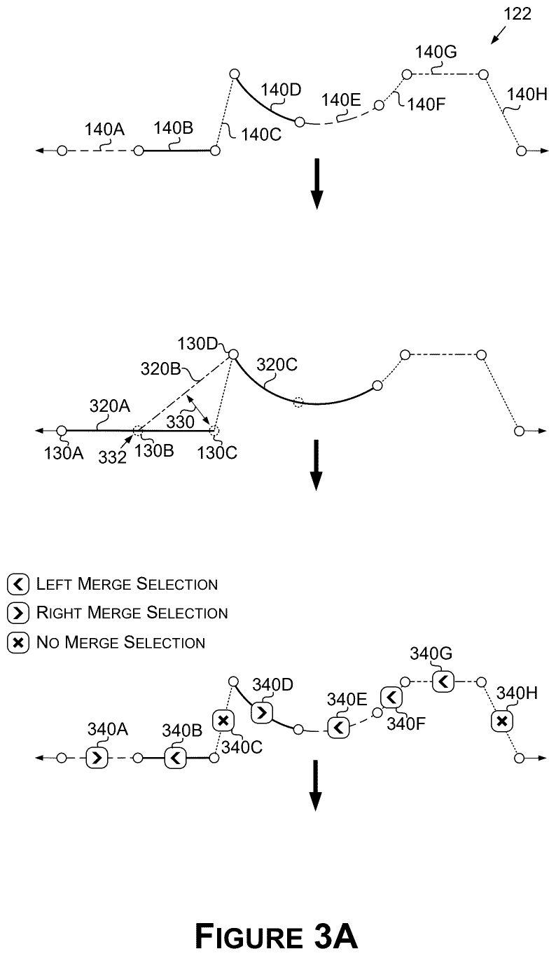

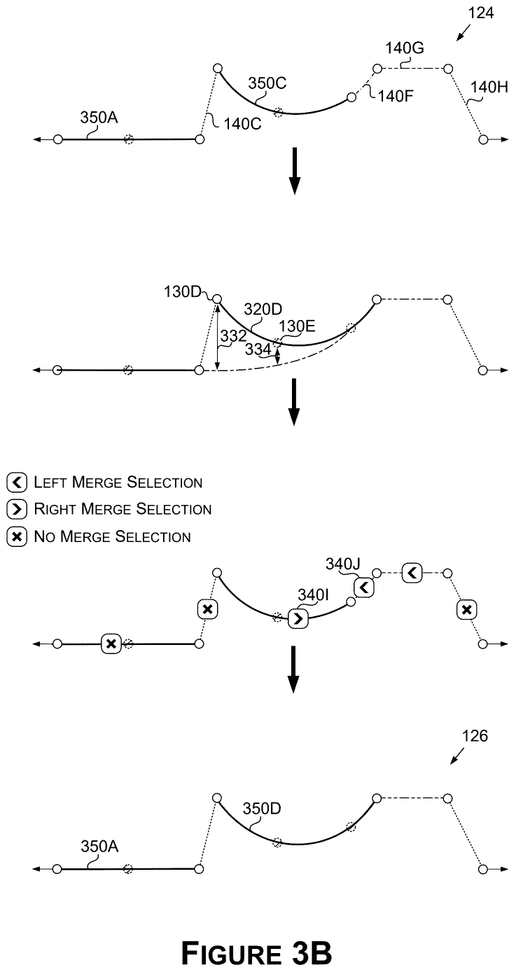

As an overview, the process may include a segment determiner(s) 102 receiving and/or determining reference geometry 120 (e.g., a sequence of points). The segment determiner 102 may use the reference geometry 120 to determine and/or generate geometric segments corresponding to the reference geometry 120 (e.g., using arc-length parameterization), such as geometric segments 122. A merge candidate determiner(s) 104 may receive the geometric segments 122 determined and/or generated by the segment determiner 102 and may determine and/or generate one or more merge candidates (e.g., merge candidates 320A and 320B of FIG. 3A) for the geometric segments 122. A merge candidate evaluator(s) 106 may evaluate the one or more merge candidates determined and/or generated using the merge candidate determiner 104. An update determiner(s) 108 may determine one or more updates (if any) to the geometric segments 122 based at least on the evaluation performed using the merge candidate evaluator 106. A segment updater(s) 110 may apply the updates (is any) determined using the update determiner 108 to the geometric segments 122 to, for example, result in geometric segments 124 which may reflect the updates. In at least one embodiment, an iteration manager(s) 112 may determine whether to further refine the geometric segments 124, for example, using the merge candidate determiner 104, the merge candidate evaluator 106, the update determiner 108, and the segment updater 110 in an additional iteration that may be similar to the iteration used to refine the geometric segments 122. The additional iteration(s) may, for example, result in geometric segments 126, which the iteration manager 112 may provide to a downstream component(s) 114 for performing further computing operations.

The segment determiner(s) 102 may use various approaches for receiving and/or determining the reference geometry 120. In at least one embodiment, the reference geometry 120 corresponds to any form of geometry to which geometric segments (e.g., a sequence of geometric segments), such as the geometric segments 122 may be fit. By way of example, and not limitation, the segment determiner(s) 102 may determine and/or generate the reference geometry 120 using or based at least on a representation of one or more shapes or paths to be approximated. The representation may be provided from a variety of potential sources including, but not limited to, any combination of user input (e.g., hand-drawn shapes), digitized images, and/or 3D scans.

In at least one embodiment, the segment determiner(s) 102 may determine the reference geometry 120 based at least on preprocessing geometry data to reduce noise and/or remove outliers. The segment determiner(s) 102 may analyze the geometry data to identify key features such as sharp corners, inflection points, and/or areas of high curvature. These features may serve as anchor points or constraints for the geometric segment fitting. As an example, the features may correspond to one or more points of which 130A, 130B, 130C, 130D, 130E, 130F, 130G, 130H, and 130I (also referred to as “points 130”) are shown in FIG. 1.

In at least one embodiment, the process 100 is used for image vectorization, for example, to convert raster images to vector graphics. For image vectorization, the reference geometry 120 may correspond to edge contours extracted from a raster image. The contours, for example, may include pixel coordinates that define the boundaries between different color regions and/or objects in the image. The segment determiner(s) 102 may segment the contours into sections that can be approximated by individual geometric segments (e.g., Bézier curves). The downstream component(s) 114 may perform various computing operations using the vector graphics produced using the process 100.

In at least one embodiment, the process 100 is used for printed circuit board (PCB) design, manufacturing, and/or lithography (e.g., of PCBs or other substrates such as semiconductors). By way of example, and not limitation, the reference geometry 120 may correspond to traces that connect components and/or component shapes or placement locations. For example, the segment determiner(s) 102 may define the reference geometry 120 based at least on a series of waypoints or connection points that the trace(s) and/or shapes are to pass through, in accordance with constraints imposed by other components and/or design rules. The downstream component(s) 114 may perform various manufacturing operations using the PCB design (a representation of one or more portions of a PCB layout) produced using the process 100. The segment determiner(s) 102 may determine the reference geometry 120 based at least on criteria for continuity and/or smoothness, such as for boundaries between surface patches (e.g., to ensure surfaces join smoothly).

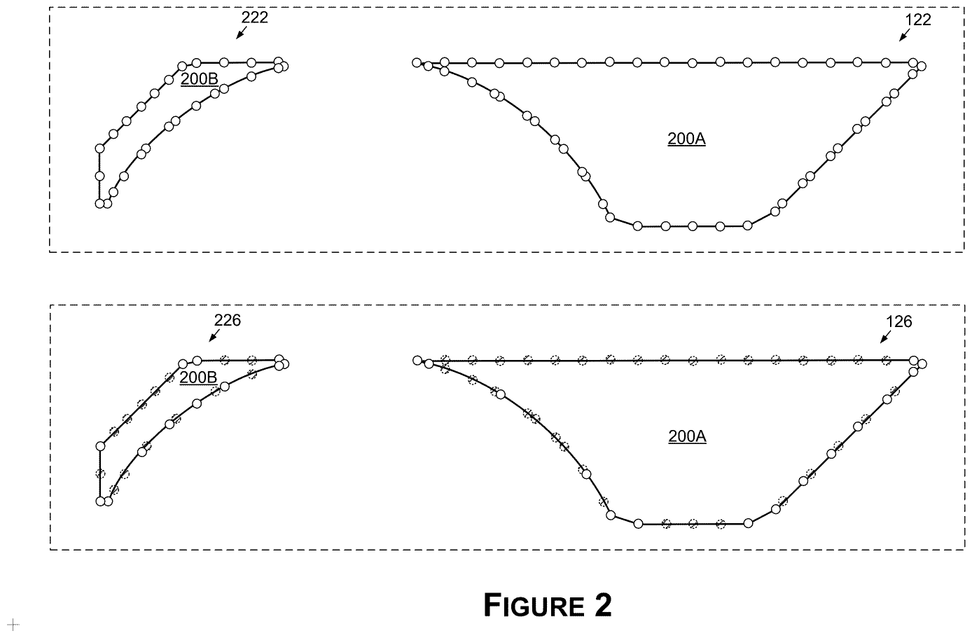

Referring now to FIG. 2, FIG. 2 includes example illustrations of sequences of geometric segments fit with respect to a printed circuit board design, in accordance with some embodiments of the present disclosure. The PCB design includes sections 200A and 200B corresponding to reference geometry. In at least one embodiment the process 100 may be respectively applied to the sections 200A and 200B to fit geometric segments to the sections 200A and 200B. For example, the process 100 may be used to refine the geometric segments 122 into the geometric segments 126 for the section 200A. The process 100 may also be used to refine geometric segments 222 into geometric segments 226 for the section 200B.

In at least one embodiment, the process 100 is used for font design. By way of example, and not limitation, the reference geometry 120 may correspond to glyph outlines based on calligraphy and/or letterforms. The segment determiner(s) 102 may define the reference geometry 120 to create mathematically precise representations of the glyphs that can be scaled and rendered at various sizes.

In at least one embodiment, the process 100 is used for annotation to generate ground truth data (e.g., labels) for training and/or verifying one or more machine learning models. By way of example, and not limitation, the reference geometry 120 may correspond to objects or image features, such as road curvature, vehicle and/or object trajectories, and/or object shapes (e.g., bounding shapes). The segment determiner(s) 102 may define the reference geometry 120 to create mathematically precise representations of the glyphs that can be scaled and rendered at various sizes.

In at least one embodiment, the process 100 is used for animation and/or motion design. By way of example, and not limitation, the reference geometry 120 may correspond to paths for object movement and/or camera trajectories. The segment determiner(s) 102 may define the reference geometry 120 based at least on keyframes or waypoints that define the position and/or orientation of an object at specific times with the reference geometry 120 being used for interpolation to create smooth motion.

The segment determiner 102 may use the reference geometry 120 to determine and/or generate geometric segments corresponding to the reference geometry 120 (e.g., using arc-length parameterization), such as the geometric segments 122. The geometric segments 122 may form a sequence of geometric segments with a geometric segment(s) between a pair of the points 130, of which geometric segments 140A, 140B, 140C, 140D, 140E, 140F, 140G, and 140H (also referred to as “geometric segments 140”) are shown in FIG. 1.

The segment determiner 102 may use various approaches to determine the geometric segments 122. As a non-limiting example, in at least one embodiment, the segment determiner 102 estimates tangents at each point 130 using finite differencing. For a point 130, the tangent may be approximated based at least on a vector between the neighboring points 130 to the point 130. The estimated tangents may be used to determine the direction of a cubic Bézier curve segment between each pair of consecutive points 130. Control points for each segment may be positioned along the tangent lines, for example, at one-third of the segment length from each point 130. As a result, the segment determiner 102 may produce the geometric segments 122 comprising a series of connected cubic Bézier curves that pass through all points 130, with the tangent estimations ensuring continuity (e.g., a continuous first derivative) across segment boundaries.

Thus, each geometric segment of the geometric segments 122 may correspond to a sequence of the points or features 130 (e.g., one or more of the points 130). For example, the geometric segment 140A corresponds to the points 130A and 130B and the geometric segment 140B corresponds to the points 130B and 130C. While in the example shown, each geometric segment of the geometric segments 122 corresponds to two of the points 130 (e.g., a start and end point), in other examples, one or more of the geometric segments 122 may correspond to more or fewer of the points 130 and/or may start or end before or after a corresponding point 130.

Referring now to FIGS. 3A and 3B, FIGS. 3A and 3B include a data flow diagram of a sequence of geometric segments 122 being fit to a sequence of points 130, in accordance with some embodiments of the present disclosure. As indicated in FIG. 3A, the merge candidate determiner(s) 104 may receive the geometric segments 122 determined and/or generated using the segment determiner 102 and may determine and/or generate one or more merge candidates (e.g., merge candidates 320A and 320B of FIG. 3A) for the geometric segments 122. In at least one embodiment, a merge candidate may correspond to a combination of the points 130 associated with at least two of the geometric segments 140 and/or a combination of one or more of the geometric segments 140. For example, the merge candidate 320A corresponds to a combination of the points 130A and 130B associated with the geometric segment 140A and the points 130B and 130C associated with the geometric segment 140B. Similarly, the merge candidate 320B corresponds to a combination of the points 130B and 130C associated with the geometric segment 140B and the points 130C and 130D associated with the geometric segment 140C.

While the merge candidates 320A and 320B are shown, in various embodiments, the merge candidate determiner 104 may determine and/or generate any number of merge candidates for any number of the points 130 and/or geometric segments 140. In at least one embodiment, the merge candidate determiner 104 determines at least one merge candidate for a given geometric segment 140. For example, the merge candidates 320A and 320B may be determined for the geometric segment 140B with each merge candidate 320A and 320B corresponding to the points 130B and 130C associated with the geometric segment 140B. The merge candidate 320A corresponds to the geometric segment 140B and at least one segment (and/or sequence of the points 130) to the left of the segment (e.g., the geometric segment 140A). Thus, the merge candidate 320A may be referred to as a left merge candidate for the geometric segment 140B. Similarly, the merge candidate 320B corresponds to the geometric segment 140B and at least one segment (and/or sequence of the points 130) to the right of the segment (e.g., the geometric segment 140C). Thus, the merge candidate 320B may be referred to as a right merge candidate for the geometric segment 140B.

In at least one embodiment, threads may respectively be assigned segments of the geometric segments 122. For example, each thread may be assigned (e.g., via parallelized or serial code) a respective geometric segment of the geometric segments 122. The merge candidate determiner 104 may be implemented using the threads, which may each determine (e.g., in parallel) one or more merge candidates for the segment(s) assigned to the thread. For example, each thread (e.g., in parallel) may determine and/or generate at least one left merge candidate and at least one right merge candidate for a geometric segment 140 assigned to the thread. In at least one embodiment, a left merge candidate for one thread and/or geometric segment may be a right merge candidate for another thread and/or geometric segment (e.g., for a left neighboring geometric segment) or vice versa. For example, the merge candidate 320A may be a right merge candidate for the geometric segment 140A and the merge candidate 320B may be a left merge candidate for the geometric segment 140C.

The merge candidate determiner(s) 104 may use various potential approaches to determine a merge candidate(s). In at least one embodiment, the merge candidate determiner 104 determines a merge candidate for a sequence of the points 130 using a similar approach as used to determine the geometric segments 122. For example, the merge candidate determiner 104 may estimate tangents at start and end points 130 of a sequence of the points 130 for which the merge candidate is being generated (e.g., omitting one or more intervening points). As an example, to generate the merge candidate 320A, the merge candidate determiner 104 may fit a geometric segment to the points 130A and 130C (e.g., excluding the point 130B as an anchor point). In various examples, one or more merge candidates may be determined, selected, and/or generated for a sequence of the points 130 based at least on one or more of one or more relative positions, distances, angles, and/or other geometric relationships between one or more of the points 130 in the set.

The merge candidate evaluator(s) 106 may evaluate the one or more merge candidates determined and/or generated using the merge candidate determiner(s) 104. For example, the merge candidate evaluator(s) 106 may evaluate the merge candidates to determine whether to replace one or more of the geometric segments 140 with the merge candidate(s) and/or to select from multiple options for replacement of the geometric segment(s) 140.

In at least one embodiment, the evaluation includes the merge candidate evaluator 106 evaluating how well a merge candidate fits the sequence of the points 130 that corresponds to the merge candidate. In at least one embodiment, the merge candidate evaluator 106 may evaluate the fit using one or more criteria corresponding to the fit, such as one or more proximities between the merge candidate and one or more of the points 130 in the sequence of points (e.g., such as a maximum distance between a point(s) and the candidate, the average distance to the candidate, and/or or a root mean square error). Further examples of the one or more criteria include those corresponding to a candidate's geometric properties, such as based at least on curvature, smoothness, and/or tangent continuity at the points 130. Further examples may correspond to the parameterization quality of the fit, such as uniformity of parameter distribution or adherence to chord length parameterization, and/or global shape characteristics and/or local features (e.g., such as preservation of overall trends, convexity, and/or concavity).

In various examples, one or more of the criterion may be used at a hard constraint and/or a soft constraint with respect to being selected for replacing a corresponding geometric segment(s) 140. In at least one embodiment, a merge candidate may be selected or rejected for a merge based at least on the evaluation comparing the one or more criteria to one or more threshold values and/or computing a score or ranking based at least on the one or more criteria (e.g., based at least on a magnitude(s) of the one or more criteria to favor closer fits to the points).

FIG. 3A shows a distance 330 between the merge candidate 320B and the point 130C, which corresponds to a proximity of the merge candidate 320B to the point 130C. FIG. 3A also shows a distance 332 between the merge candidate 320A and the point 130B (which may be equal to or near zero in this example), which corresponds to a proximity of the merge candidate 320A to the point 130B. In at least one embodiment, the merge candidate evaluator(s) 106 may select the merge candidate 320A for the geometric segment 140B based at least on the distance 332 being less than the distance 330. In at least one embodiment, a score for a merge candidate may be computed based at least on a square of a distance between a point 130 and the merge candidate. In at least one embodiment, where a merge candidate corresponds to multiple interior points 130, the evaluation and/or score may be based at least on the control point 130 having a maximum distance to the merge candidate or the evaluation and/or score may correspond to an aggregation of the distances.

A result of an evaluation by a thread and/or the merge candidate evaluator(s) 106 may include, by way of example, any combination of a selection(s) of a preferred or required merge candidate(s) for a merge, a ranking or scoring of an evaluated merge candidate(s) for the merge, and/or a selection(s) of an unpreferred or prohibited merge candidate(s) for the merge. In at least one embodiment, the merge candidate evaluator(s) 106 (e.g., each thread) selects for one or more geometric segments between a left merge candidate, a right merge candidate, or a no merge option. A selection of a no merge option may be based at least on each of the merge candidates for a geometric segment violating a selection constraint, such as where for each merge candidate, the one or more criteria exceed the one or more threshold values (e.g., the distance or proximity-based criterion).

FIG. 3A shows examples of selections 340A, 340B, 340C, 340D, 340E, 340F, 340G, and 340H (also referred to as “selections 340”) which may be made (e.g., by respective threads) for geometric segments 140A, 140B, 140C, 140D, 140E, 140F, 140G, and 140H respectively. As an example, FIG. 3A indicates a selection of the merge candidate 320A for the geometric segment 140B from the merge candidates 320A and 320B.

The update determiner(s) 108 may determine one or more updates (if any) to the geometric segments 122 based at least on the evaluation(s) performed using the merge candidate evaluator(s) 106. For example, the update determiner(s) 108 may determine to replace one or more of the geometric segments 140 with one or more merge candidates selected and/or evaluated with respect to the geometric segment(s) 140. The segment updater(s) 110 may perform the updated determined using the update determiner(s) 108. FIG. 3B shows an example in which based at least on the selections 340, the segment updater(s) 110 has replaced the geometric segments 140A and 140B with a geometric segment 350A corresponding to the merge candidate 320A and has replaced the geometric segments 140D and 140E with a geometric segment 350C corresponding to a merge candidate 320C to result in the geometric segments 124.

In at least one embodiment, the update determiner(s) 108 may reject or accept a merge candidate(s) that is evaluated by multiple threads and/or for multiple geometric segments for an update based at least on the results of the evaluations. For example, where the results are compatible for the merge candidate(s) (e.g., both results select and/or agree with the merge) the merge candidate may be included in the update. Thus, for example, the merge candidate 320A may be accepted for an update as the selection 340A and the selection 340B agree with respect to the merge candidate 320A. Where the results are incompatible for the merge candidate(s) (e.g., at least one result does not select and/or agree with the merge) the merge candidate may be rejected from the update. For example, other than for the merge candidates 320A and 320C, there are no mutual agreements between the selections 340 regarding merge candidates. Thus, only the merge candidates 320A and 320C have been accepted in the example shown. In at least one embodiment, the update determiner(s) 108 evaluates (e.g., compares) the results (e.g., selections 340) corresponding to each adjacent segment (e.g., a left merge candidate for one segment that is a right merge for another segment) to determine whether to include the merge candidate in an update.

The iteration manager(s) 112 may determine whether to further refine the geometric segments 124, for example, using the merge candidate determiner 104, the merge candidate evaluator 106, the update determiner 108, and the segment updater 110 in an additional iteration that may be similar to the iteration used to refine the geometric segments 122. The iteration manager(s) 112 may use various potential criteria to determine whether to perform an additional iteration. For example, the iteration manager(s) 112 may initiate an iteration while the number of iterations is below a threshold value (e.g., to perform a fixed or maximum number of iterations) and/or based at least on at least one merge candidate being accepted for the previous iteration (e.g., to terminate the iterations when no geometric segments are replaced).

By way of example, FIG. 3B shows that in a subsequent iteration, the merge candidate determiner 104 may determine a merge candidate 320D as a right merge candidate for the geometric segment 320D and a left merge candidate for the geometric segment 140F. The merge candidate evaluator(s) 106 may evaluate the merge candidate 320D based at least on distances 332 and 334 for the points 130D and 130E. For example, as the distance 332 is greater than the distance 334 a result of the evaluation and/or score for the merge candidate 320D may correspond to the distance 332. As a selection 3401 for the geometric segment 320D agrees with a selection 340J for the geometric segment 140F, the update determiner(s) 108 may select the merge candidate 320D for an update to the geometric segments 124. Thus, the segment updater(s) 110 may replace the geometric segments 350C and 140F with a geometric segment 350D that corresponds to the merge candidate 320D, resulting in the geometric segments 126.

In at least one embodiment, the process 100 may operate on one or more sections, such as the sections 200A and/or 200B of FIG. 2. Each section may correspond to an array of geometric segments and an “is closed” boolean used to indicate whether the section is geometrically closed or open. The process 100 may be performed using a mutable mapping X(p) between points (e.g., the point 130) and geometric segments (e.g., the geometric segments 140). The process 100 may further be performed with the merge candidate evaluator(s) 106 using a metric B(C, p) to score a fit between a merge candidate or geometric segment C and a given point p. The merge candidate determiner(s) 104 may use a merge function M(Cₐ, C_{b}) which generates a merge candidate from input geometric segments Cₐ and C_{b}.

In at least one embodiment, the process 100 may be configured to attempt to reduce the number of geometric segments in each section and update the mapping X (p) between the points and geometric segments while maintaining or ensuring the property that B(X(p), p)≤Bₘₐₓ for all p. In at least one embodiment, Bₘₐₓ may correspond to the one or more thresholds used by the merge candidate evaluator(s) 106 to evaluate the merge candidates.

In at least one embodiment, the merge candidate determiner(s) 104 may, for each section S having c-many geometric segments S₀, S₁, S₂, . . . , S_{c-1}, define a left merge candidate L(Sᵢ) of Sᵢ as Sᵢ₋₁ if i>1, as undefined if i=0 and S is not closed, and S_{c-1} if i=0 and S is closed. Further, the merge candidate determiner(s) 104 may, for each section S having c-many geometric segments S₀, S₁, S₂, . . . , S_{c-1}, define a right merge candidate R(Sᵢ) of Sᵢ using an inverse approach. In at least one embodiment, a left merge candidate L(Sᵢ) and a right merge candidate R(Sᵢ) may be defined for all geometric segments but S_{c-1} for non-closed sections S. Each ordered pair (L(Sᵢ), Sᵢ), or (R(Sᵢ), Sᵢ) may include an adjacent pair of geometric segments.

In at least one embodiment, the merge candidate determiner(s) 104, for each adjacent pair of curve segments (Cₐ, C_{b}) of each section S, defines a merge candidate using the merge function M(Cₐ, C_{b}) to produce a left merge candidate M_{L}(C_{b}) and a right merge candidate M_{R}(Cₐ). For each adjacent pair of geometric segments (Cₐ, C_{b}) of each section S, the merge candidate evaluator(s) 106 may compute a score B_{M}(Cₐ, C_{b}) as a maximum score of B(M(Cₐ, C_{b}, p) for all points p where X(p)=Cₐ or X(p)=C_{b}. In at least one embodiment, for each geometric segment Sᵢ, the left merge candidate score B_{L}(Sᵢ) may be set to infinite or a high value when L(Sᵢ) does not exist and as B_{M}(Sᵢ, L(Sᵢ)) otherwise. Similarly, for each geometric segment Sᵢ, the right merge candidate score B_{R}(Sᵢ) may be set to infinite or a high value when R(Sᵢ) does not exist and as B_{M}(Sᵢ, R(Sᵢ)) otherwise.

In at least one embodiment, to determine merge option selections, such as the selections 340, the merge candidate determiner(s) 104 may use a merge option selection function W(C), which may return a selection (e.g., a token) from various potential options. For example, the merge option selection function W(C) may return a left merge selection D_{L} if B_{L}(C)<B_{R}(C) and B_{L}(C)≤Bₘₐₓ. Otherwise, the merge option selection function W(C) may return a right merge selection D_{R} if B_{R}(C)<B_{L}(C) and B_{R}(C)≤Bₘₐₓ. Otherwise, the merge option selection function W(C) may return a no merge selection D_{X}.

In at least one embodiment, the update determiner(s) 108 may, for each adjacent pair of geometric segments (Cₐ, C_{b}), where W(Cₐ)=D_{R} and W(C_{b})=D_{L}, determine to replace the geometric segments (Cₐ, C_{b}) with a merge candidate M(Cₐ, C_{b}) to reduce the number of geometric segments in the section S. The segment updater(s) 110 may perform the replacement, which may include updating the mapping X(p) between points and geometric segments such that all of the points (e.g., the points 130) with X(p)=Cₐ or X(p)=C_{b} are now mapped to the merge candidate M(Cₐ, C_{b}). In this example, the geometric segment Cₐ may be referred to as “merged right” when replaced by the right merge candidate M_{R}(Cₐ) and the geometric segment C_{b} may be referred to as “merged left” when replaced by the left merge candidate M_{L}(C_{b}). By way of example, and not limitations, the merge option selection function W(C) returning D_{L} (or D_{R}) may be used as a necessary but not sufficient condition for a segment to merge left (or right), as the merge may only occur for matched pairs in some embodiments.

In at least one embodiment, for a parallel processing implementation (e.g., using one or more graphics processing units (GPUs)), a fit task may refer to a section S of geometric segments and a sequence of points that may be mapped to the geometric segments using the mapping X (p). The geometric segments and points of a section S may be tightly packed (e.g., with no unused entries) in an array of geometric segments C₀, C₁, C₂, . . . and points p₀, p₁, p₂, . . . . Each fit task may include a section start

$${T}_{i}^{start}$$

(inclusive) and a section end

$${T}_{i}^{end}$$

(exclusive), with

$$a = {T}_{i}^{start} and b = {T}_{i}^{end} ,$$

the i-th section's geometric segments being Cₐ, Cₐ₊₁, . . . , C_{b-1}. As the geometric segments may be tightly packed, the section start

$${T}_{i}^{start}$$

need not be explicitly stored, as us may implicitly be 0 for the 0-th section (i=0) and implicitly the section end

$${T}_{i - 1}^{end}$$

for subsequent sections.

For each geometric segment Cⱼ, in the array of geometric segments, the index

$${C}_{j}^{T}$$

of the fit task (e.g., section S) that contains the geometric segment Cⱼ may be attached, as well as the arclength

$${C}_{j}^{A}$$

of the geometric segment Cⱼ, and a segment fate Fⱼ (e.g., capturing merge information).

An array of merge candidates M₀, M₁, M₂, . . . may be allocated parallel to the array of geometric segments. For each merge candidate Mⱼ, in the array of merge candidates, the index

$${M}_{j}^{T}$$

of the fit task (e.g., section S) that contains the inputs used to generate the merge candidate Mⱼ may be attached, as well as the arclength

$${M}_{j}^{A}$$

of the merge candidate Mⱼ, and a merge score

$${M}_{j}^{B}$$

of for the merge candidate Mⱼ.

In at least one embodiment, for each point pᵢ, the point to geometric segment index

$${p}_{j}^{C}$$

may be attached with

$$j = {p}_{j}^{C} , {C}_{j} = X ( {p}_{i} ) .$$

The initial state of these values may define the initial state of the mapping X(p) from points to geometric segments. For each point pᵢ, the arclength

$${p}_{j}^{A}$$

from the start point of Cⱼ to pᵢ may be attached.

In at least one embodiment, each component of the process 100 may process the geometric segments or points of all fit tasks in parallel. The components may be operated sequentially or one or more of the components may be operated at least partially in parallel, for example, depending on timing or memory requirements and/or tradeoffs.

In at least one embodiment, points for one or more of the fit tasks may be read in parallel, and the segment determiner(s) 102 may process the points to generate initial geometric segments (e.g., using a 1:1 point-to-segment mapping). The merge candidate determiner(s) 104 may generate merge candidates for the geometric segments (e.g., one merge candidate per-adjacent pair of geometric segments). The update determiner(s) 108 may compute, for each geometric segment Cⱼ, the merge candidate scores B(Cⱼ) and the merge option selection W(Cⱼ). The update determiner(s) 108 may compute the per-segment fate, which may include a selected merge direction

$${F}_{j}^{D} ,$$

a new index

$${F}_{j}^{N} ,$$

and a cached or estimated arclength

$${F}_{j}^{A}$$

(the arclength

$${C}_{j}^{A} ) .$$

The segment updater(s) 110 may conditionally replace pairs of geometric segments with selected merge candidates. The segment updater(s) 110 may also conditionally update per-point state, such as the point to geometric segment index

$${p}_{j}^{c}$$

and the accumulated arclength

$${p}_{j}^{A} .$$

In at least one embodiment, the iteration manager(s) 112 determines whether to end the process 100 (e.g., determines whether no geometric segments have been replaced). If the iteration manager(s) 112 determines to continue the process 100, for a subsequent iteration, the section start

$${T}_{i}^{start}$$

may be swapped with the section end

$${T}_{i}^{e n d}$$

using double buffering and the process 100 may continue.

In at least one embodiment, the iterations may continue until all fit tasks converge or some other criterion is satisfied. However, an iteration may process the fit tasks logically independently, but in parallel. In various examples, an iteration may process all of the fit tasks, some of the fit tasks, and/or one or more fit tasks may be processed in some iterations but not others (e.g., in an alternating fashion). In at least one embodiment, the subsection of the array of geometric segments (the section start

$${T}_{i}^{start}$$

and the section end

$${T}_{i}^{e n d} )$$

allocated for each fit task may change depending on a lower-numbered fit tasks' behavior. In at least one embodiment, the iteration manager(s) 112 may determine to continue or discontinue one or more portions of one or more iterations for some fit tasks but not others, for example, based at least on tracking convergence (e.g., whether a segment was replaced) and/or other criteria for each fit task separately. For example, the iteration manager(s) 112 may determine or select to skip the merge candidate determiner(s) 104 and the merge candidate evaluator(s) 106 for one or more fit tasks based at least on the one or more criteria, may assume the no merge selection D_{X} for the one or more fit tasks, and/or may skip the per-point update for the one or more fit tasks.

In at least one embodiment, the merge candidate determiner(s) 104 may generate merge candidates for the geometric segments (e.g., one merge candidate per-adjacent pair of geometric segments) using a respective processor(s) and/or thread(s) assigned to each geometric segment entry Cₐ in the array of geometric segments. The processors and/or threads may, for each geometric segment entry Cₐ, set the merge score

$${M}_{a}^{B}$$

to infinity or some other value (e.g., default value) if the right neighbor R(Cₐ)=C_{b} does not exist. To calculate the index of the right neighbor, the merge candidate determiner(s) 104 may use the index

$$i = {C}_{a}^{T}$$

of the containing fit task to bounds check against the section end

$${T}_{i}^{e n d}$$

and the section start

$${T}_{i}^{start} .$$

Otherwise, the processors and/or threads may, for each entry Cₐ, set the merge candidate Mₐ=M(Cₐ, C_{b}), set the fit task index

$${M}_{j}^{T} = {C}_{a}^{T} ( or {C}_{b}^{T} ) ,$$

set the arclength

$${M}_{j}^{A} = {C}_{a}^{A} + {C}_{b}^{A} ,$$

and initialize the merge score

$${M}_{a}^{B}$$

to 0 or some other default value.

In at least one embodiment, each geometric segment Cₐ may have a left merge candidate and a right merge candidate (e.g., except for segments at the end of non-closed sections). However, the array of merge candidates may be the same size as the array of geometric segments, as each merge candidate Mⱼ can simultaneously be the right merge candidate of the geometric segment Cⱼ and the left merge candidate of R(Cⱼ).

Various different approaches are available for the merge candidate determiner(s) 104 to compute the merge candidate M(Cₐ, C_{b}) (e.g., for each geometric segment C using the assigned processor(s) and/or thread(s)). In at least one embodiment, a point q₀ may refer to the start point p₀ of the geometric segment Cₐ, with a chord length parameterization u=0. A point q₁ may refer to a common point p₃ of the geometric segment Cₐ (e.g., the start point p₀ of the geometric segment C_{b}) with a chord length parameterization

$$u = {C}_{a}^{A} / ( {C}_{a}^{A} + {C}_{b}^{A} ) .$$

Also, a point q₂ may refer to the end point p₃ of the geometric segment C_{b}, with a chord length parameterization u=1. A tangent \hat{t}₁ may refer to the tangent vector at the start point p0 of the geometric segment Cₐ, which may also be referred to as the direction of a curve of the geometric segment Cₐ at the start point p₀. A tangent \hat{t}₂ may refer to the tangent vector at the end point p₃ of the geometric segment C_{b}, which may also be referred to as the direction of a curve of the geometric segment C_{b} at the end point p₃. The merge candidate M(Cₐ, C_{b}) may then correspond to a geometric segment (e.g., a cubic Bézier curve) fit to the points q₀, q₁, and q₂ given the tangent \hat{t}₁ and the tangent \hat{t}₂. For example, the merge candidate determiner(s) 104 may adjust control points of the merge candidate M(Cₐ, C_{b}) to minimize or reduce the error between the points q₀, q₁, and q₂, the tangent \hat{t}₁, and the tangent \hat{t}₂ and corresponding features of the merge candidate M(Cₐ, C_{b}).

The merge candidate evaluator(s) 106 may compute the score B_{M}(Cₐ, C_{b}) for each point pᵢ using a processor(s) and/or thread(s) assigned to the point pᵢ. In at least one embodiment, the

$$j = {p}_{i}^{C}$$

(the point to geometric segment index), the merge candidate Mₐ=M_{L}(Cⱼ), and the merge candidate M_{b}=M_{R}(Cⱼ). If M_{L}(Cⱼ) exists, the merge score

$${M}_{a}^{B}$$

may be set to

$$max ( {M}_{a}^{B} , B ( {M}_{a} , {p}_{i} ) ) .$$

If M_{R}(Cⱼ) exists, the merge score

$${M}_{b}^{B}$$

may be set to

$$max ( {M}_{b}^{B} , B ( {M}_{b} , {p}_{i} ) ) .$$

In at least one embodiment, the processor(s) and/or thread(s) may compute the metric B(C, pᵢ) where u may refer to an estimated value (e.g., based at least on chord length parameterization) such that the distance between the point pᵢ and the geometric segment C(u) is minimized. For the geometric segment

$$C = {M}_{a} , u = ( {C}_{a}^{A} + {p}_{i}^{A} ) / {M}_{a}^{A}$$

and for the geometric segment

$$C = {M}_{b} , u = {p}_{i}^{A} / {M}_{b}^{A} .$$

The processor(s) and/or thread(s) assigned to the point pᵢ may optimize u (e.g., using a Newton Raphson root find) to minimize the distance between the point p and the geometric segment C(u).

In at least one embodiment, the merge candidate evaluator(s) 106 may be configured to compute at least one aggregate value of the at least one first score with the at least one second score. For example, the aggregate value may correspond to

$$max ( {M}_{a}^{B} , B ( {M}_{a} , {p}_{i} ) )$$

or a statistical combination of the score for each of the points corresponding to a merge candidate. In at least one embodiment, the at least one aggregate value may be computed using one or more atomic operations of parallel processing circuitry, such as an atomic Max operation that is performed using the scores computed using the metric B(C, pᵢ). As an example, the atomic Max operation may be performed using scores corresponding to the points 130D and 130E to score the merge candidate 320D.

In at least one embodiment, the merge candidate evaluator(s) 106 may be configured to avoid ties between the scores B_{L}(C) and B_{R}(C), which may prevent merges, as the merge option selection function W(C) may otherwise provide the no merge selection D_{X} in such scenarios. For example, to avoid a tie, the merge candidate evaluator(s) 106 may account for the parity of the index of the geometric segment C within its section S or use some other strategy. Also, in at least one embodiment, a score B(C) that is below a threshold value may be treated as a score of zero to mitigate the potential impact of noise.

As described herein, the update determiner(s) 108 may compute the per-segment fate Fⱼ attached to each geometric segment Cⱼ. In at least one embodiment, the fate Fⱼ includes an estimated arclength

$${F}_{j}^{A}$$

of the geometric segment Cⱼ, the selected merge direction

$${F}_{j}^{D}$$

for the geometric segment Cⱼ (e.g., left, right, or no merge), and a new index

$${F}_{j}^{N}$$

for the geometric segment Cⱼ. In at least one embodiment, the update determiner(s) 108 may store the estimated arclength

$${F}_{j}^{A}$$

and the new index

$${F}_{j}^{N}$$

as a union as the value may not be simultaneously needed. For example, the estimated arclength

$${F}_{j}^{A}$$

may only be needed when the selected merge direction

$${F}_{j}^{D}$$

is the right merge selection D_{R} and the new index

$${F}_{j}^{N}$$

may be defined with reference to the right neighbor R(Cⱼ) in such cases.

The segment updater(s) 110 may, based at least on the computed fate Fⱼ for the geometric segment Cⱼ, replace old geometric segments with new geometric segments. For example, for all adjacent pairs of geometric segments (Cₐ, C_{b}), if the geometric segments are to be replaced with the merge candidate M(Cₐ, C_{b}), the segment updater(s) 110 may set the selected merge direction

$${F}_{a}^{D}$$

to the right merge selection D_{R}, the selected merge direction

$${F}_{b}^{D}$$

to the left merge selection D_{L}, and the new indices

$${F}_{a}^{N} and {F}_{b}^{N}$$

to the index of M(Cₐ, C_{b}) in an updated version of the array of geometric segments. For all other geometric segments Cⱼ, the segment updater(s) 110 may set the selected merge direction

$${F}_{j}^{D}$$

to the no merge selection D_{X} and the new index

$${F}_{j}^{N}$$

for the geometric segment Cⱼ may remain the same in the updated version of the array of geometric segments.

In at least one embodiment, the fate Fⱼ may be computed in parallel for each geometric segment Cⱼ. In at least one embodiment, to compute the new index

$${F}_{j}^{N}$$

for each geometric segment Cⱼ, the segment updater(s) 110 may define Eⱼ as 0 if the selected merge direction

$${F}_{j}^{D}$$

is the right merge selection D_{R} and 1 otherwise. Then, the segment updater(s) 110 may compute the array of new index

$${F}_{j}^{N}$$

using an exclusive prefix sum

$${\sum }_{j = 0}^{a - 1} {E}_{j} ,$$

for entries where the merge direction

$${F}_{j}^{D}$$

is not the right merge selection D_{R}, and with C_{b}=the right neighbor R(Cₐ), the same as the new index

$${F}_{j}^{N}$$

for entries where the merge direction

$${F}_{j}^{D}$$

is the right merge selection D_{R}. In at least one embodiment, the prefix sum may be implemented on one or more parallel processors using a decoupled look-back. Using disclosed approaches, the new index values may be computed where Eⱼ serves as a filter predicate in performing an array select (filter) operation. The array selection operation may be configured to always select index values of non-merged segments, while for merged segments, the left segment of the pair may be semi-arbitrarily selected to fail the predicate (i.e. be removed). The right segment of the pair (which merged left) may be substituted with the merged segment. In other examples, the role of the left and right segments may be reversed.

In at least one embodiment, the update determiner(s) 108 may update the array of geometric segments using a parallel scatter operation. Each geometric segment Cⱼ may be assigned a respective parallel processor(s) and/or thread(s). If the selected merge direction

$${F}_{j}^{D}$$

is the no merge selection D_{X}, the

$${F}_{j}^{N} - th$$

entry for the new array of geometric segments may be set to the geometric segment Cⱼ. If the selected merge direction

$${F}_{j}^{D}$$

is the left merge selection D_{L}, the

$${F}_{j}^{N} - th$$

entry for the new array of geometric segments may be set to the left merge candidate M_{L}(Cⱼ). If the selected merge direction

$${F}_{j}^{D}$$

is the right merge selection D_{R}, no value contribution may be made. This approach may allow for a reduction in the length of the array of geometric segments and the suballocation for each section S, so the section start

$${T}_{i}^{start}$$

and the section end

$${T}_{i}^{end}$$

may also be updated. Using a decoupled look-back, the update to the array of geometric segments may be performed in-place.

The state for each point pi may be updated (e.g., in parallel) based at least on setting

$$b = {p}_{i}^{c}$$

(the current point to geometric segment index) and updating

$${p}_{i}^{c}$$

to the new index

$${F}_{b}^{N} .$$

If the selected merge direction

$${F}_{b}^{D}$$

is the left merge selection D_{L}, the geometric segment Cₐ may be set to the left neighbor L(C_{b}) and the arclength

$${p}_{j}^{A}$$

may be increased by the estimated arclength

$${F}_{a}^{A}$$

(the left neighbor L(C_{b}) may be based on the old vales of the section start

$${T}_{i}^{start}$$

and the section end

$${T}_{i}^{end} ) .$$

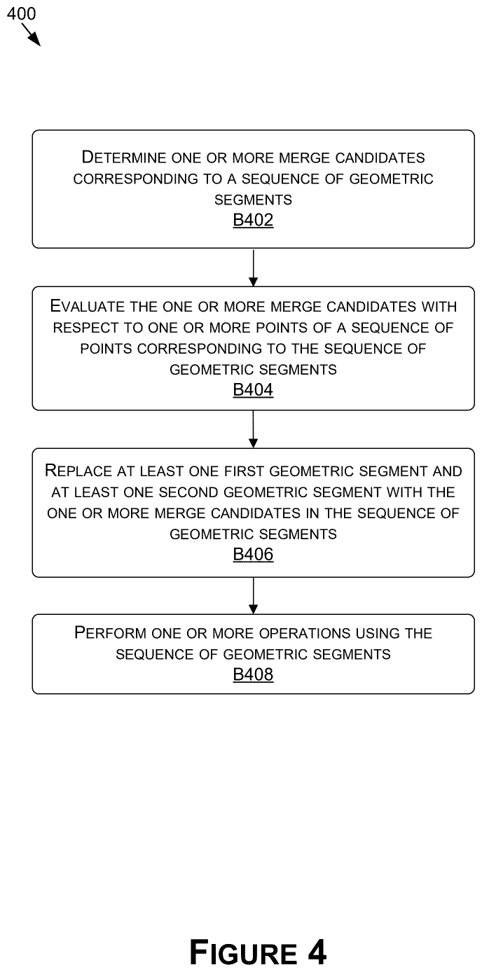

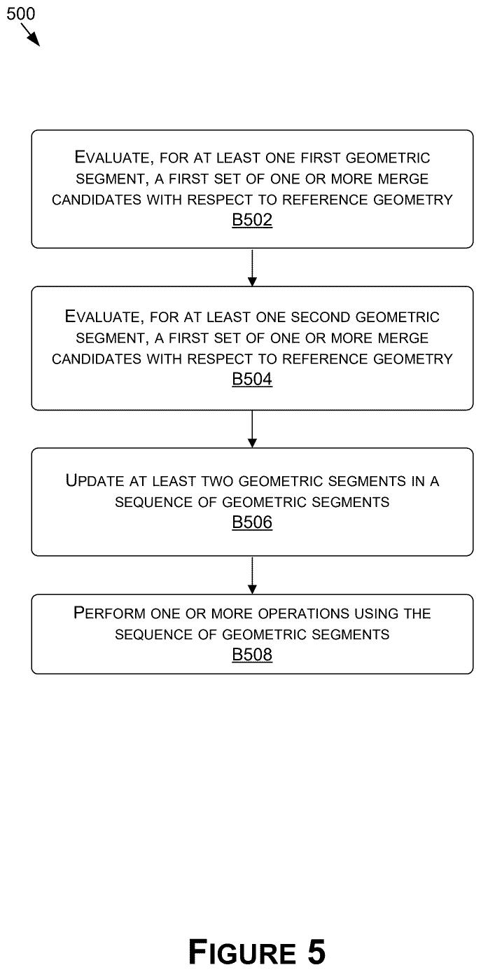

Referring now to FIGS. 4 and 5, each block of methods 400 and 500, and other methods described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods are described, by way of example, with respect to FIGS. 1, 3A, and 3B. However, these methods may additionally or alternatively be executed by any one system, or any combination of systems, including, but not limited to, those described herein.

Referring now to FIG. 4, FIG. 4 is a flow diagram showing a method 400 for replacing geometric segments in a sequence of geometric segments based on an evaluation of one or more merge candidates, in accordance with some embodiments of the present disclosure. The method 400, at block B402, includes determining one or more merge candidates corresponding to a sequence of geometric segments. For example, the merge candidate determiner(s) 104 may determine the merge candidate 320B corresponding to the geometric segments 140A and 140B of the geometric segments 122.

At block B404, the method 400 includes evaluating the one or more merge candidates with respect to one or more points of a sequence of points corresponding to the sequence of geometric segments. For example, the merge candidate evaluator(s) 106 may evaluate the merge candidate 320B with respect to the point 130B.

At block B406, the method 400 includes replacing at least one first geometric segment and at least one second geometric segment with the one or more merge candidates in the sequence of geometric segments. For example, the segment updater(s) 110 may, based at least on the evaluating, replace the geometric segments 140A and 140B with the merge candidates 320B in the geometric segments 122 to result in the geometric segments 124.

At block B408, the method 400 includes performing one or more operations using the sequence of geometric segments. For example, the downstream component(s) 114 may, based at least on the replacing, perform one or more operations for a machine using the sequence of geometric segments.

Referring now to FIG. 5, FIG. 5 is a flow diagram showing a method 500 for updating a sequence of geometric segments based on evaluations of sets of merge candidates for geometric segments, in accordance with some embodiments of the present disclosure.

The method 500, at block B502, includes evaluating, for at least one first geometric segment, a first set of one or more merge candidates with respect to reference geometry. For example, the merge candidate evaluator(s) 106 may evaluate, for the geometric segment 140A in the geometric segments 122 associated with reference geometry (e.g., the points 130), the merge candidate 320A with respect to the reference geometry.

At block B504, the method 500 includes evaluating, for at least one second geometric segment, a second set of one or more merge candidates with respect to the reference geometry. For example, the merge candidate evaluator(s) 106 may evaluate, for the geometric segment 140B in the geometric segments 122 associated with reference geometry (e.g., the points 130), the merge candidate 320A with respect to the reference geometry.

At block B506, the method 500 includes updating at least two geometric segments in a sequence of geometric segments. For example, based at least on the evaluating of the merge candidate 320A for the geometric segment 140A and the merge candidate 320A for the geometric segment 140B, the segment updater(s) 110 may determine the geometric segments 124.

At block B508, the method 500 includes performing one or more operations using the sequence of geometric segments. For example, the downstream component(s) 114 may, based at least on the replacing, perform one or more operations for a machine using the sequence of geometric segments.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

1. A method comprising: determining one or more merge candidates corresponding to at least one first geometric segment in a sequence of geometric segments and at least one second geometric segment in the sequence of geometric segments; evaluating the one or more merge candidates with respect to one or more points of a sequence of points corresponding to the sequence of geometric segments; based at least on the evaluating, replacing the at least one first geometric segment and the at least one second geometric segment with the one or more merge candidates in the sequence of geometric segments; and based at least on the replacing, performing one or more operations for a machine using the sequence of geometric segments.

2. The method of 1, wherein the replacing is based at least on: identifying a first selection of the one or more merge candidates from a first plurality of merge options for the at least one first geometric segment; identifying a second selection of the one or more merge candidates from a second plurality of merge options for the at least one second geometric segment; and determining the first selection matches the second selection.

3. The method of any of 1-2, wherein the sequence of geometric segments includes a sequence of Bézier curves fit to the sequence of points.

4. The method of any of 1-3, wherein the replacing comprises selecting, based at least on the evaluating, between a left merge candidate for the at least one first geometric segment, a right merge candidate for the at least one first geometric segment, and a no merge option for the at least one first geometric segment.

5. The method of any of 1-4, wherein the evaluating includes determining at least one value indicating at least one proximity between the one or more merge candidates and at least one first point of the one or more points, and the replacing is based at least on the at least one proximity.

6. The method of any of 1-5, wherein the evaluating includes: determining, using at least one first thread, at least one first score for the one or more merge candidates with respect to at least one first point of the one or more points; determining, using at least one second thread, at least one second score for the one or more merge candidates with respect to at least one second point of the one or more points; and computing at least one aggregate value of the at least one first score with the at least one second score, wherein the replacing is based at least on the at least one aggregate value.

7. The method of any of 1-6, further comprising: determining one or more second merge candidates corresponding to the at least one first geometric segment and at least one third geometric segment in the sequence of geometric segments; and selecting, from the one or more merge candidates and the one or more second merge candidates, at least one merge candidate for the replacing based at least on the evaluating.

8. The method of any of 1-7, wherein the replacing is performed based at least on an agreement between a first merge option selection made by at least one first thread corresponding to the at least one first geometric segment and a second merge option selection made by at least one second thread corresponding to the at least one second geometric segment.

9. The method of any of 1-8, wherein the at least one first geometric segment corresponds to at least one first point of the sequence of points, the at least one second geometric segment corresponds to at least one second point of the sequence of points, and the determining the one or more merge candidates includes fitting the one or more merge candidates to the at least one first point and the at least one second point.

10. A system comprising: one or more processors to perform operations including: evaluating, for at least one first geometric segment in a sequence of geometric segments associated with reference geometry, a first set of one or more merge candidates with respect to the reference geometry; evaluating, for at least one second geometric segment in the sequence of geometric segments, a second set of one or more merge candidates with respect to the reference geometry; based at least on the evaluating of the first set of one or more merge candidates and the second set of one or more merge candidates, updating at least two geometric segments in the sequence of geometric segments; and based at least on the updating, performing one or more operations for a machine using the sequence of geometric segments.

11. The system of 10, wherein the updating is based at least on: identifying a first selection of a merge candidate from the first set of one or more merge candidates; identifying a second selection of the merge candidate from the second set of one or more merge candidates; and determining the first selection matches the second selection.

12. The system of any of 10-11, wherein the sequence of geometric segments includes a sequence of Bézier curves fit to the reference geometry.

13. The system of any of 10-12, further comprising selecting, based at least on the evaluating of the first set of one or more merge candidates, between a left merge candidate for the at least one first geometric segment, a right merge candidate for the at least one first geometric segment, and a no merge option for the at least one first geometric segment, wherein the updating is based at least on the selecting.

14. The system of any of 10-13, wherein the evaluating of the first set of one or more merge candidates includes determining at least one value indicating a proximity between the first set of one or more merge candidates and at least one point of the reference geometry.

15. The system of any of 10-14, wherein updating is performed based at least on an agreement between a first merge option selection made based at least on the evaluating of the first set of one or more merge candidates and a second merge option selection made based at least on the evaluating of the second set of one or more merge candidates.

16. The system of any of 10-15, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).

17. At least one processor comprising: one or more circuits to perform one or more Printed Circuit Board (PCB) lithography operations for a machine using a PCB design corresponding to a sequence of geometric segments fit to reference geometry associated with the PCB design, the sequence of geometric segments being determined based at least on an evaluation of one or more merge candidates for at least two geometric segments in the sequence of geometric segments with respect to the reference geometry.

18. The at least one processor of 17, wherein the sequence of geometric segments is determined based at least on: identifying a first selection of a merge candidate from the one or more merge candidates for a first geometric segment of the at least two geometric segments; identifying a second selection of the merge candidate from the one or more merge candidates for a second geometric segment of the at least two geometric segments; an determining the first selection matches the second selection.

19. The at least one processor of any of 17-18, wherein the sequence of geometric segments is determined based at least on selecting, based at least on the evaluation, between a left merge candidate for at least one geometric segment in the sequence of geometric segments, a right merge candidate for the at least one geometric segment, and a no merge option for the at least one geometric segment.

20. The at least one processor of any of 17-19, wherein the at least one processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).

What is claimed is:

1. A method comprising
determining one or more merge candidates corresponding to at least one first geometric segment in a sequence of geometric segments and at least one second geometric segment in the sequence of geometric segments;
evaluating the one or more merge candidates with respect to one or more points of a sequence of points corresponding to the sequence of geometric segments;
based at least on the evaluating, replacing the at least one first geometric segment and the at least one second geometric segment with the one or more merge candidates in the sequence of geometric segments; and
based at least on the replacing, performing one or more operations for a machine using the sequence of geometric segments.

2. The method of claim 1, wherein the replacing is based at least on:
identifying a first selection of the one or more merge candidates from a first plurality of merge options for the at least one first geometric segment;
identifying a second selection of the one or more merge candidates from a second plurality of merge options for the at least one second geometric segment; and
determining the first selection matches the second selection.

3. The method of claim 1, wherein the sequence of geometric segments includes a sequence of Bézier curves fit to the sequence of points.

4. The method of claim 1, wherein the replacing comprises selecting, based at least on the evaluating, between a left merge candidate for the at least one first geometric segment, a right merge candidate for the at least one first geometric segment, and a no merge option for the at least one first geometric segment.

5. The method of claim 1, wherein the evaluating includes determining at least one value indicating at least one proximity between the one or more merge candidates and at least one first point of the one or more points, and the replacing is based at least on the at least one proximity.

6. The method of claim 1, wherein the evaluating includes:
determining, using at least one first thread, at least one first score for the one or more merge candidates with respect to at least one first point of the one or more points;
determining, using at least one second thread, at least one second score for the one or more merge candidates with respect to at least one second point of the one or more points; and
computing at least one aggregate value of the at least one first score with the at least one second score, wherein the replacing is based at least on the at least one aggregate value.

7. The method of claim 1, further comprising:
determining one or more second merge candidates corresponding to the at least one first geometric segment and at least one third geometric segment in the sequence of geometric segments; and
selecting, from the one or more merge candidates and the one or more second merge candidates, at least one merge candidate for the replacing based at least on the evaluating.

8. The method of claim 1, wherein the replacing is performed based at least on an agreement between a first merge option selection made by at least one first thread corresponding to the at least one first geometric segment and a second merge option selection made by at least one second thread corresponding to the at least one second geometric segment.

9. The method of claim 1, wherein the at least one first geometric segment corresponds to at least one first point of the sequence of points, the at least one second geometric segment corresponds to at least one second point of the sequence of points, and the determining the one or more merge candidates includes fitting the one or more merge candidates to the at least one first point and the at least one second point.

10. A system comprising
one or more processors to perform operations including:
evaluating, for at least one first geometric segment in a sequence of geometric segments associated with reference geometry, a first set of one or more merge candidates with respect to the reference geometry;
evaluating, for at least one second geometric segment in the sequence of geometric segments, a second set of one or more merge candidates with respect to the reference geometry;
based at least on the evaluating of the first set of one or more merge candidates and the second set of one or more merge candidates, updating at least two geometric segments in the sequence of geometric segments; and
based at least on the updating, performing one or more operations for a machine using the sequence of geometric segments.

11. The system of claim 10, wherein the updating is based at least on:
identifying a first selection of a merge candidate from the first set of one or more merge candidates;
identifying a second selection of the merge candidate from the second set of one or more merge candidates; and
determining the first selection matches the second selection.

12. The system of claim 10, wherein the sequence of geometric segments includes a sequence of Bézier curves fit to the reference geometry.

13. The system of claim 10, further comprising selecting, based at least on the evaluating of the first set of one or more merge candidates, between a left merge candidate for the at least one first geometric segment, a right merge candidate for the at least one first geometric segment, and a no merge option for the at least one first geometric segment, wherein the updating is based at least on the selecting.

14. The system of claim 10, wherein the evaluating of the first set of one or more merge candidates includes determining at least one value indicating a proximity between the first set of one or more merge candidates and at least one point of the reference geometry.

15. The system of claim 10, wherein updating is performed based at least on an agreement between a first merge option selection made based at least on the evaluating of the first set of one or more merge candidates and a second merge option selection made based at least on the evaluating of the second set of one or more merge candidates.

16. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

17. At least one processor comprising
one or more circuits to perform one or more Printed Circuit Board (PCB) lithography operations for a machine using a PCB design corresponding to a sequence of geometric segments fit to reference geometry associated with the PCB design, the sequence of geometric segments being determined based at least on an evaluation of one or more merge candidates for at least two geometric segments in the sequence of geometric segments with respect to the reference geometry.

18. The at least one processor of claim 17, wherein the sequence of geometric segments is determined based at least on:
identifying a first selection of a merge candidate from the one or more merge candidates for a first geometric segment of the at least two geometric segments;
identifying a second selection of the merge candidate from the one or more merge candidates for a second geometric segment of the at least two geometric segments; and
determining the first selection matches the second selection.

19. The at least one processor of claim 17, wherein the sequence of geometric segments is determined based at least on selecting, based at least on the evaluation, between a left merge candidate for at least one geometric segment in the sequence of geometric segments, a right merge candidate for the at least one geometric segment, and a no merge option for the at least one geometric segment.

20. The at least one processor of claim 17, wherein the at least one processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).
